(19) United States
(12) Patent Application Publication
(10) Pub. No.: US 2002/0086267 A1
(43) Pub. Date: Jul. 4, 2002

(54) Apparatus and method for determining an individually adapted, non-prefabricated training unit

(76) Inventors: Thomas Birkhoelzer, Radolfzell (DE); Juergen Vaupel, Weisendorf (DE)

Correspondence Address: SCHIFF HARDIN & WAITE, 6600 SEARS TOWER, 233 S WACKER DR, CHICAGO, IL, 60606-6473, US

(21) Appl. No.: 09/994,309

(22) Filed: Nov. 26, 2001

(30) Foreign Application Priority Data
Nov. 24, 2000 (DE) 10058572.8
Nov. 9, 2001 (DE) 10155094.4

(51) Int. Cl. G09B 19/00

(52) U.S. Cl. 434/118

(57) ABSTRACT

In an apparatus and a method for automatic determination of an individually adapted, non-prefabricated training unit based on the individual learning need of a trainee, an input device, a data bank containing all training modules with their dependencies on one another, and a selection device for generating the training unit (7) from the existing training modules are provided. The dependencies of training modules on one another are taken into consideration in generating the training unit in response to an entry by the trainee made via the input device.

### BACKGROUND OF THE INVENTION

1. Field of the Invention

The present invention is directed to an apparatus and to a method for determining a training unit based on the learning need of a trainee, of the type having an input device, a data bank of all training modules and a selection device.

2. Description of the Prior Art

Electronic learning, referred to as learning, is based on the use of prefabricated content modules or training modules of, for example, 20 through 40 minutes in length that are linked to form interconnected training units that can typically amount to a number of hours. This corresponds to the compilation of lectures and exercises to conform a multi-day course of classical training.

This compilation to form different courses is presently implemented by the training vendors. The training vendor packages the content modules offered by that vendor to form certain prefabricated training units from which the person to be trained or the training participant, for example a student, can subsequently select. This is the continuation of the traditional learning paradigm without the flexibility of the new media being fully utilized.

PCT Application WO 99/24953 discloses a system that proceeds on the basis of a specific training unit composed of many different training modules. How this training unit is generated from the training modules is not disclosed. Summaries can be produced from this training unit, or each trainee can be individually enabled to navigate in the training unit, such as, for example, to repeat lectures. A fixed hierarchic coupling, and thus a fixed, prescribed configuration of the training modules, are assumed.

PCT Application WO 00/42 589 A2 discloses a system that dynamically generates training units based on preferences and prior knowledge of the user.

The subject matter of European Application 1 003 142 also proceeds on the basis of a finished training unit, whereby an additional “reserve training unit” is also offered when a test is not passed.

An individual compilation without considering dependencies also ensues in the subject matter of U.S. Pat. No. 6,039,575. The student is asked at least one question per learning objective (training module). This ensures that no learning objective is forgotten. Given a realistic data bank of several hundred training modules (an offering is only of interest at all for a user beginning with this size since there is then a realistic chance of the user finding something for his needs), however, too many questions would arise in this way.

### SUMMARY OF THE INVENTION

An object of the present invention is to provide an apparatus and a method of the type initially described wherein a training unit is generated that is truly adapted to the individual needs of the trainee.

In an apparatus, this object is inventively achieved by fashioning the apparatus for the automatic determination of an individually adapted, non-prefabricated training unit based on the individual learning need of the trainee, by storing all training modules with their dependencies on one another in a data bank and wherein the selection device for generating the training unit from the existing training modules is fashioned such that dependencies of training units on one another are taken into consideration. Selection criteria can be the need of the -trainee and/or the dependencies of the modules. Dependencies can, for example, denote affiliation, prerequisite and/or identical difficulty level.

The generation of training units ensues with the selection unit after specification of the learning need and the generated configuration is not explicitly stored in the data bank. This bundling of content modules or training modules to form training units on the basis of requests of the training participant is a reversal of the traditional principle and is called reverse packeting. As a result, the inventive system and method allow a training unit to be individually generated in a manner supported by considering dependencies of the training modules, for example, modules that are necessary as prior knowledge for other modules. These dependencies need not be simply hierarchic; thus, for example, the necessity of a training module can also be derived from the combination of several interests. Taking these dependencies into consideration, however, is important for the successful use of an individual configuration of training units since the trainee does not always know these dependencies and thus cannot specify a complete list of interests.

The training participant specifies his or her learning need, for example on the basis of certain key words. The apparatus automatically generates a training unit from the existing training modules that is individually adapted to the student. Differing from a mere search engine, dependencies of the content modules among one another are also taken into consideration.

Inventively, the selection device can be fashioned such that it takes uniform levels of the expert knowledge of the content modules into consideration. The expert knowledge of the content modules is employed as a level of the expert knowledge for which the training module is conceived (for example, beginner, expert). For covering a learning need, for example, content modules are thus offered that are designed for uniform levels of ability in the field. Moreover, training can be integrated that represent prerequisites for other content modules without having explicitly specified a learning requirement.

It has proven advantageous when the selection device is fashioned such that it takes content modules as prerequisites for other content modules into consideration.

A simple structure and evaluation is obtained when dependencies of the training modules are stored in the data bank.

The questioning is simplified when the input device is fashioned for the input of key words that are stored in the data bank and on the basis of which the selection device determines the appertaining training modules for defining a training unit. The key words are entered by a user, for example by selection from a prescribed list.

It has proven advantageous when the device is employed in medical education.

The object is inventively achieved by the following steps for a method:

a) Input of requests about the learning objective, the background knowledge of the training participant and/or requested topics as characteristic of the learning needs of the training participant;

b) Determination of all affected training modules;

c) Identification of the training modules dependent on the training modules and the background knowledge of the training participant; and

d) Definition of a training unit individually adapted to the training participant from the training modules that have been determined and identified.

### DESCRIPTION OF THE DRAWINGS

FIG. 1 is a schematic illustration of an apparatus for determining an individually adapted, non-prefabricated training unit, constructed and operating in accordance with the principles of the present invention.

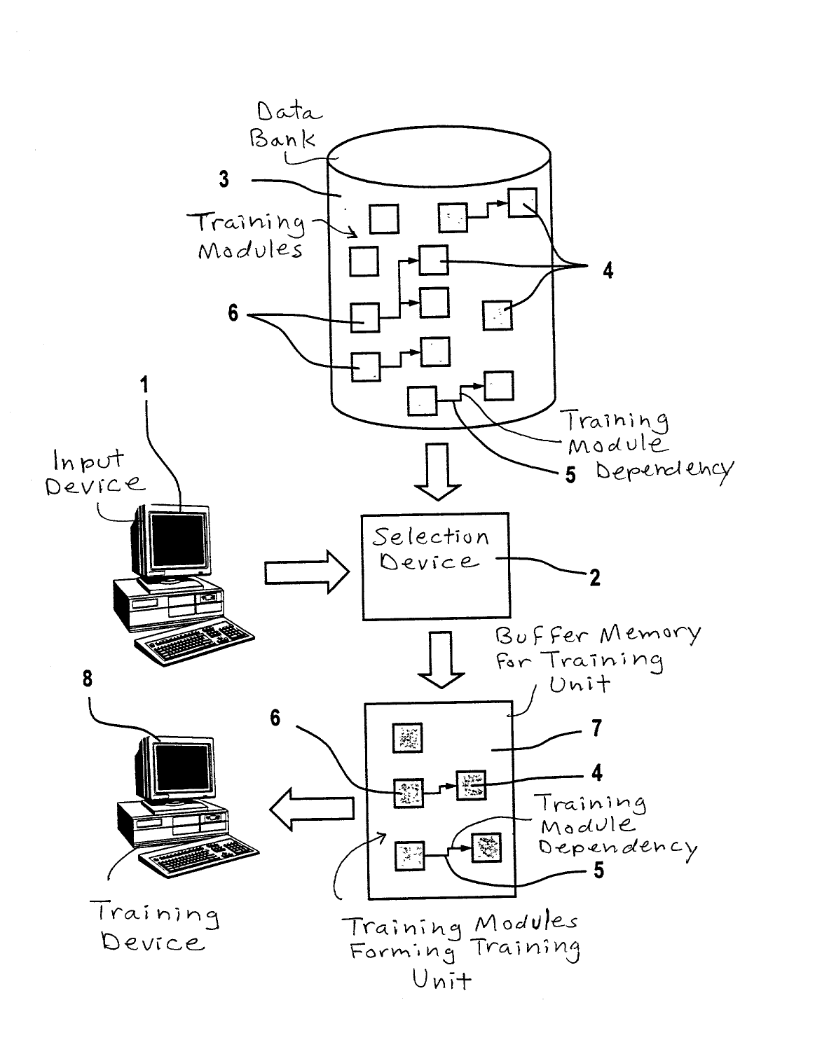

### DESCRIPTION OF THE PREFERRED EMBODIMENTS

The figure shows a system that has an input device 1, for example a personal computer (PC), that is connected to a selection device 2. A data bank 3 in which training modules 4 and their dependencies 5 to other and/or subordinated training modules 6 are stored is connected to the selection device 2. On the basis of inputs with the input device 1, the selection device 2 selects the training unit required for the training participant from these training modules 4 and 6. The required training unit is stored, for example, in a buffer memory 7 and can be fetched by the training participant at any time and shown on a output device and/or training device 8. The output device 8 can be the same PC as the input device 1.

On the basis of the inputs at the input device 1, the selection device 2 determines those training modules from the entirety of training modules 4 that meet the learning objective of the training participant. The dependencies of the training modules 5 on one another are also taken into consideration, i.e. when a training module 4 that, for example, builds on a training module 6 is selected, co-offered to the training participant.

In the environment of medical imaging, for example, this means that a physician specifies his or her learning need as “3D evaluation for a medical software platform without extensive prior knowledge”.

In response thereto, the physician is offered the following training modules as courses that cover this request overall, whereby the request, the physician's background knowledge and the selected topics are taken into consideration:

a) Introduction into the user paradigms of the software platform;

b) Introduction into filming for documentation;

c) Introduction into 3D technology,

d) Advanced 3D technology; and

e) 3D diagnostics.

The training modules a) through c) are derived from the basic program for MRTA, the training module d) is derived from the course program for expert users, and the training module e) is derived from a program for continuing medical education.

Dependent on learning need, thus, a training unit 7 is compiled that is composed of directly required training modules 4. Further, training modules 6 are likewise allocated thereto that are linked with the training modules 4 via dependencies 5. These are derived from the existing background knowledge of the physician.

Although modifications and changes may be suggested by those skilled in the art, it is the intention of the inventors to embody within the patent warranted hereon all changes and modifications as reasonably and properly come within the scope of their contribution to the art.

We claim as our invention:

1. An apparatus for automatically determining an individually adapted, non-prefabricated training unit, comprising:
an input device adapted to receive an entry from a training participant;
a data bank in which a plurality of training modules are stored, said training modules having a dependencies on each other and said dependencies also being stored in said data bank; and
a selection device connected to said input device and to said data bank for, in response to, and dependent on, said entry, generating a training unit by combining a number of said training modules taking said dependencies of said training modules on each other into consideration.

2. An apparatus as claimed in claim 1 wherein each of said training modules has a content with an expert knowledge level associated therewith, and wherein said selection unit generates said training unit from training modules respectively having uniform levels of expert knowledge associated therewith.

3. An apparatus as claimed in claim 1 wherein each of said modules has a content, and wherein the content of some of said modules is a prerequisite for the content of other modules, and wherein said selection device takes said prerequisite contents into consideration in generating said training unit.

4. An apparatus as claimed in claim 1 wherein said input device allows entry of key words as part of said entry, and wherein said key words are stored in said data bank, and wherein said selection device generates said training unit based on said key words.

5. An apparatus as claimed in claim 1 wherein said data bank is a data bank containing a plurality of medical education training modules as said training modules.

6. A method for automatically determining learning needs of a training participant and defining a customized training unit for said trainee, comprising the steps of:
(a) entering, into a computerized system, an entry characterizing learning needs of a training participant selected from the group consisting of learning objectives of a training participant, background knowledge of a training participant, and a requested topic as characteristics of the learning needs of the training participant;
(b) from among a plurality of training modules stored in said computerized system, determining all training modules responsive to said entry;
(c) from among said training modules responsive to said entry, identifying selected training modules, dependent on said background knowledge; and
(d) defining a training unit customized to said training participant from the training modules identified in steps (b) and (c).
